(19) United States
(12) Patent Application Publication
(10) Pub. No.: US 2024/0384951 A1
(43) Pub. Date: Nov. 21, 2024

(54) HEAT EXCHANGER HAVING HYDROPHOBIC LAYER, COMPOSITE MATERIAL FOR HEAT EXCHANGER AND MANUFACTURING METHOD OF HEAT EXCHANGER

(71) Applicant: ZHEJIANG SANHUA INTELLIGENT CONTROLS CO., LTD., Shaoxing City (CN)

(72) Inventors: JIANHUA TANG, Shaoxing City (CN); HAI HUANG, Shaoxing City (CN); SHURUI YU, Shaoxing City (CN); LINJIE HUANG, Shaoxing City (CN)

(21) Appl. No.: 18/786,499

(22) Filed: Jul. 27, 2024

Related U.S. Application Data
(63) Continuation of application No. PCT/CN2023/072888, filed on Jan. 18, 2023.

(30) Foreign Application Priority Data
Jan. 27, 2022 (CN) 202210101761.0

(51) Int. Cl. F28F 21/08

(52) U.S. Cl. CPC F28F 21/089; F28F 2265/00

(57) ABSTRACT

A heat exchanger has a channel for fluid flow. The heat exchanger includes a matrix and a coating layer coated on a surface of the matrix, the coating layer includes a hydrophobic coating layer, and the hydrophobic coating layer includes a low surface energy silane material and corrosion inhibiting particles. The low surface energy silane material in synergy with the corrosion inhibiting particles provides the heat exchanger with excellent corrosion resistance. A composite material includes a low surface energy silane material and corrosion inhibiting particles, so as to improve the corrosion resistance of the heat exchanger. The manufacturing method of the heat exchanger is also provided.

### CROSS-REFERENCE TO RELATED APPLICATION

This patent application is a bypass continuation of International (PCT) Patent Application No. PCT/CN2023/072888, filed on Jan. 18, 2023, which further claims priority of a Chinese Patent Application No. 202210101761.0, filed on Jan. 27, 2022 and titled “HEAT EXCHANGER, COMPOSITE MATERIAL FOR HEAT EXCHANGER AND SURFACE TREATMENT METHOD FOR HEAT EXCHANGER”, the entire content of which is incorporated herein by reference.

### TECHNICAL FIELD

The present disclosure belongs to a field of heat exchanging device and in particular, relates to a heat exchanger, a composite material for a heat exchanger and a manufacturing method of a heat exchanger.

### BACKGROUND

In the related art, hydrophobic sol is coated on a surface of a heat exchanger to form a hydrophobic coating layer. The hydrophobic coating layer leads to a large contact angle of corrosive solution on the surface of the heat exchanger, and the corrosive solution is not easy to spread, so as to reduce a direct contact area of the corrosive solution on the surface of the heat exchanger. Besides, the hydrophobic coating layer itself barriers a corrosive media to some extent. Therefore, the hydrophobic coating layer can improve the corrosion resistance of the heat exchanger. However, since there may be microporous defects or pores caused by low cross-linking in the hydrophobic coating layer, these microporous defects or pores are prone to become paths for the corrosive media to diffuse to the metal matrix.

In order to further improve the corrosion resistance of the heat exchanger, the related art needs to be improved.

### SUMMARY

An object of the present disclosure is to provide a heat exchanger with good corrosion resistance performance, and accordingly, the present disclosure also provides a composite material used for a heat exchanger, and a manufacturing method of a heat exchanger.

The present disclosure provides a heat exchanger, including:
a matrix having a channel for fluid flow, and
a coating layer coated on at least part of a surface of the matrix, the coating layer including a hydrophobic layer,
where the hydrophobic layer includes a low surface energy silane material and corrosion inhibiting particles distributed in the low surface energy silane material.

The hydrophobic coating layer on the surface of the heat exchanger of the present disclosure contains the low surface energy silane material and the corrosion inhibiting particles. The low surface energy silane material in synergy with the corrosion inhibiting particles provides the heat exchanger of the present disclosure with superior corrosion resistance relative to existing heat exchangers.

The present disclosure also provides a composite material for a heat exchanger, including:
a low surface energy silane material, the low surface energy silane material including a silane with a hydrophobic group grafted thereon, the hydrophobic group being selected from at least one of a hydrocarbon group, a halogen atom and a nitro group; and
corrosion inhibiting particles, the corrosion inhibiting particles being configured to release corrosion inhibiting ions, the corrosion inhibiting ions being selected from at least one type of cerium ions, vanadium ions, lanthanum ions, praseodymium ions, molybdenum ions, zinc ions and zirconium ions.

The composite material can be used to form an anti-corrosion coating layer containing the corrosion inhibiting particles on the surface of the heat exchanger, so as to improve the corrosion resistance of the heat exchanger.

The present disclosure also provides a manufacturing method of a heat exchanger, including following steps:
providing a matrix having a channel for fluid flow;
providing a composite material, the composite material including a low surface energy silane material and corrosion inhibiting particles; and
coating the composite material on at least part of a surface of the matrix, and curing, to form a hydrophobic coating layer coated on at least part of the surface of the matrix.

The manufacturing method of the heat exchanger of the present disclosure can be used to form the hydrophobic coating layer containing corrosion inhibiting particles on the surface of the heat exchanger, so as to improve the corrosion resistance of the heat exchanger.

### BRIEF DESCRIPTION OF DRAWINGS

FIG. 1 is a structural schematic view of a heat exchanger according to an embodiment of the present disclosure;

FIG. 2 is an enlarged schematic view of a assembled structure of some of the components of the heat exchanger of FIG. 1;

FIG. 3 is a schematic view of a section of a hydrophobic coating layer on a surface of a matrix of a heat exchanger according to an embodiment of the present disclosure;

FIG. 4 is a schematic view of a section of a hydrophobic coating layer on a surface of a matrix of a heat exchanger according to another embodiment of the present disclosure;

FIG. 5 is a schematic view of a section of a hydrophobic coating layer and a rare earth conversion film on a surface of a matrix of a heat exchanger according to an embodiment of the present disclosure;

FIG. 6 is surface topography of samples of Comparative example 1 and Comparative example 2 after a 48 h salt spray test;

FIG. 7 is surface topographies of samples of Comparative example 1 and Comparative example 2 after a 96 h salt spray test;

FIG. 8 is surface topographies of samples of Embodiment 4 and Comparative example 1 after a 240 h salt spray test; and

FIG. 9 is surface topographies of samples of Embodiment 4 and Comparative example 1 after a 96 h salt spray test.

### DETAILED DESCRIPTION

In order to better understand the technical solutions of the present disclosure, embodiments of the present disclosure are described in detail below in combination with the accompanying drawings.

It should be clear that the described embodiments are only a part of, and not all of the embodiments of the present disclosure. Based on the embodiments in the present disclosure, all other embodiments obtained by a person skilled in the art without creative labour fall within the scope of protection of the present disclosure.

In the related art of anticorrosion treatment for a metal surface, a anticorrosion coating layer on the metal surface may be a chemical conversion film formed by a reaction of a chemical reagent with a metal, a coating layer formed by depositing ions on the metal surface by means of electroplating, physical vapor deposition (PVD), etc., or a coating layer formed by applying a coating material to a surface of the metal by dip-coating, spray-coating or other means. Forming an anti-corrosion coating layer by using of green coating material is favoured due to its simple process, low cost, good product applicability, human and environmentally friendly and other characteristics.

The anticorrosion coating layer on the surface of heat exchanger product in the current market is mostly a chemical conversion film. For example, the anticorrosion coating layer on the surface of aluminium heat exchanger is mostly chemical conversion film formed by chromium salt passivation. Since hexavalent chromium is highly toxic and carcinogenic, the use of hexavalent chromium passivation coating layer has been strictly prohibited. Trivalent chromium is adopted instead of hexavalent chromium for the surface anticorrosive treatment of aluminium products in the current market, but the hazards of the trivalent chromium to the environment and the human body can still not be ignored. Based on this, the research and development of green coatings material suitable for the heat exchanger, and forming an anticorrosion coating layer on the surface of the heat exchanger by means of coating material has become an important development direction of heat exchanger surface anticorrosion technology.

In some related technologies, hydrophobic sol is coated on the surface of the heat exchanger, and then is cured to form a hydrophobic coating layer. During the curing process, the hydrophobic coating layer can be firmly bonded with the heat exchanger matrix because the groups in the hydrophobic sol condense with Me—OH on the surface of the metal matrix to form bonds, and the groups in the hydrophobic sol also cross-link with each other to form bonds and a mesh structure. The hydrophobic coating layer leads to a larger contact angle of the corrosive solution on the surface of the heat exchanger, so that the corrosive solution is not easy to spread, which reduces the direct contact area of the corrosive solution on the heat exchanger surface. In addition, the hydrophobic coating layer itself blocks corrosive medium to some extent, which can reduce contact between the metal matrix and substances, for example, oxygen, water or other corrosive substances, from the outside environment, so as to reduce or slow down the corrosion on the surface of the metal matrix caused by acid, alkali or other chemical on the one hand, and on the other hand, to reduce or slow down the electrode polarisation and depolarisation processes, and thus electrochemical corrosion of the metal matrix surface is also reduced or slowed down to a certain extent. Therefore, hydrophobic coating layer can improve the corrosion resistance of the heat exchanger.

The improvement of the corrosion resistance brought by the hydrophobic coating layer mainly depends on hydrophobic property and internal microstructure thereof. The hydrophobic property of the hydrophobic coating layer is derived from hydrophobic groups in the hydrophobic coating layer, while the internal microstructure of the hydrophobic coating layer is largely influenced by the cross-linking degree of the hydrophobic sol. Generally, the coating layer formed by a sol with a small degree of crosslinking has more pores, and the more pores there are, the less barrier effect the coating layer itself has. As the degree of crosslinking increases, the density, mechanical strength and hardness of the coating layer increases, and the barrier effect of the coating layer itself also increases, but excessive crosslinking will increase brittleness of the coating layer, which may lead to an increase in the number of microcracks in the coating layer, and even lead to rupture of the coating layer. In order to firmly attach the hydrophobic coating layer to the metal matrix, reduce microcracks generated in the coating layer and prevent the coating layer from rupture, a hydrophobic sol with an appropriate degree of crosslinking needs to be provided. Usually, the hydrophobic coating layer formed by the hydrophobic sol inevitably has some defects such as micropores or holes, which can easily become a path for corrosive media to diffuse into the metal matrix. Therefore, fillers can be added to the hydrophobic sol to increase the density and thickness of the hydrophobic coating layer, so as to improve the barrier effect of the hydrophobic coating layer itself on corrosive substances.

In order to further increase the corrosion resistance of the heat exchanger, the present disclosure improves the anticorrosion coating layer of the heat exchanger. A first aspect of the present disclosure provides a heat exchanger, the heat exchanger has a channel for flowing fluid, the heat exchanger includes a matrix and a coating layer coated on at least a portion of a surface of the matrix, the coating layer includes a hydrophobic coating layer, and the hydrophobic coating layer includes a low surface energy silane material and corrosion inhibiting particles dispersed in the low surface energy silane material.

The low surface energy silane material refers to a silane material with low surface energy. A material having low surface energy exhibits certain hydrophobic properties.

Corrosion inhibiting property refers to a property of a certain substance to prevent or slow down the corrosion of an engineering material when it exists in the environment or medium in appropriate concentration and form. Currently, substances used for anticorrosion of metal materials are also known as corrosion inhibitors, and the corrosion inhibitors can be divided into an anode-type corrosion inhibitor, a cathode-type corrosion inhibitor and a hybrid corrosion inhibitor. The anode-type corrosion inhibitor reacts in an anodic region of the metal surface to generate a product insoluble or slightly soluble in water, and the product forms a protective film covering the anode. For example, the anode-type corrosion inhibitor reacts with metal ions to generate oxides or hydroxides that form a protective film, which isolates the anode from corrosion solution, so as to control the anodic reaction. Common anode-type corrosion inhibitors are chromates, molybdates, tungstates, vanadates, nitrites, borates or other inorganic strong oxidants. The cathodic-type corrosion inhibitor reacts in a cathodic region of the metal surface to generate a product insoluble or slightly soluble in water, and the product forms a protective film covering the cathode. For example, the cathodic-type corrosion inhibitors reacts with hydroxide ions or hydrogen ions to generate oxides or hydroxide that form a protective film, which isolates the cathode from corrosion solution, so as to block the reaction through which the cathode releases electrons. Common cathodic-type corrosion inhibitor includes carbonate, phosphate and hydroxide of zinc, carbonate and phosphate of calcium, or the like. The hybrid corrosion inhibitor has two polar groups with opposite properties, which can form a film at the anode as well as at the cathode, and act as a corrosion inhibitor by blocking the diffusion of water and dissolved oxygen in water to the metal surface.

The hydrophobic coating layer on the surface of the heat exchanger of the present disclosure combines the low surface energy silane material and corrosion inhibiting particles. The low surface energy silane material provides hydrophobic properties, and the corrosion inhibiting particles filled in the internal mesh structure formed by the low surface energy silane material are firmly bonded to the heat exchanger matrix through the low surface energy silane material. When electrochemical corrosion occurs on the surface of the heat exchanger matrix, the corrosion inhibiting ions released by the corrosion inhibiting particles are configured to react with at least one type of hydrogen ions, hydroxide ions, and metal ions to generate a product insoluble or slightly soluble in water, the product covers at least one of a cathode region and an anode region of the electrochemical reaction, impeding the electrochemical reaction, so as to mitigate corrosion of the heat exchanger matrix. The corrosion inhibiting particles can be filled in the micropores or pores of the mesh structure formed by the low surface energy silane material, which increases the denseness of the coating layer, and improves the barrier effect of the coating layer on corrosive substances. The low surface energy silane material in synergy with the corrosion inhibiting particles makes the heat exchanger of the present disclosure have more excellent corrosion resistance compared to the existing heat exchanger.

In some embodiments, the corrosion inhibiting particle is configured to release corrosion inhibiting ions, the corrosion mitigating ions are selected from at least one type of cerium ions, vanadium ions, lanthanum ions, praseodymium ions, molybdenum ions, zinc ions and zirconium ions. All of the abovementioned ions are capable of reacting with other ions to generate insoluble oxides, hydroxides, or complexes in the cathode region when electrochemical corrosion occurs on the metal surface, and some of the hydroxides dehydrates to form oxides. The oxides, hydroxides, or complexes forms a film to cover the cathode region, so as to prevent corrosive substances from entering, thereby mitigating corrosion of the heat exchanger surface.

In some embodiments, the corrosion inhibiting particles are insoluble or slightly soluble in water. Generally, in 20° C. water, having a solubility of less than 0.01 g is insoluble, having a solubility of more than 0.01 g and less than 1 g is slightly soluble, having a solubility of more than 1 g and less than 10 g is soluble, and having a solubility of more than 10 g is easily soluble.

Common corrosion inhibitors are metal salts that are soluble in water. However, combining corrosion inhibiting particles of metal salts with the low surface energy silane material may leads to an unsustainable corrosion mitigating effect. For example, at an initial stage of use, the metal salt dissolves to release corrosion inhibiting ions in large quantities, and plays a good role in mitigating corrosion on the metal matrix, but it may result in a waste of corrosion mitigating ions. Besides, as the metal salt has been consumed in large quantities at the initial stage of use, the role of the coating layer in mitigating corrosion on the metal matrix at a later stage of use is limited. In addition, due to the rapid dissolution of the metal salts, micropores and pores in the low surface energy silane materials re-emerge, which may result in a sharp deterioration of the corrosion resistance of the product in the later stage of use. Therefore, corrosion inhibiting particles with a low solubility are employed in the present disclosure, these corrosion inhibiting particles release corrosion inhibiting ions at an appropriate rate, so that the corrosion inhibiting particles can be durably filled in the micropores or pores of the low-surface-energy silane material as a filler to mitigate corrosion, and the effect of corrosion mitigation can be maintained for a long time.

In some embodiments, the corrosion inhibiting particles have a resistivity of 10⁹ to 10²² Ω·cm, which means that the corrosion inhibiting particles are made from insulating materials. In this way, the corrosion inhibiting particles can also be used to slow down transfer of ions between the cathode and the anode in the electrochemical corrosion primary cell due to its insulating property, so as to hinder the overflow of the metal cations in the anode and the discharge effect generated in the cathode, i.e., have a resistive effect, thereby reducing or slowing down the electrochemical corrosion of the surface of the metal matrix.

In some embodiments, the corrosion inhibiting particles are selected from at least one of cerium oxide CeO₂, cerium trioxide Ce₂O₃, cerium tartrate C₁₂H₁₂Ce₂O₁₈, cerium cinnamate C₂₇H₂₁CeO₆, lanthanum oxide La₂O₃, vanadium oxide V₂O₅, praseodymium oxide Pr₂O₃, molybdenum oxide MoO₃, zinc oxide ZnO and zirconium oxide ZrO₂.

The mechanism of corrosion mitigation of the corrosion inhibiting particles of the present disclosure is further explained below by using cerium oxide as an example. The cerium ion has two oxidation states, Ce³⁺ and Ce⁴⁺, corresponding to the oxides Ce₂O₃ and CeO₂, respectively. Ce⁴⁺ released by CeO₂ reacts with OH⁻ ions generated in the cathode region to form the insoluble hydroxide Ce(OH)₄, which dehydrates to form CeO₂. CeO₂ forms a film covering the cathode region, so as to mitigate corrosion on the heat exchanger surface. Ce³⁺ released by Ce₂O₃ reacts with OH-ions generated in the cathode area to form the insoluble hydroxide Ce(OH)₄ or Ce(OH)₃, Ce(OH)₄ dehydrates to form CeO₂, and Ce(OH)₃ dehydrates to form Ce₂O₃ and CeO₂. In addition, the two oxides, Ce₂O₃ and CeO₂ are capable of interconverting, for example, Ce₂O₃ can be oxidized to form CeO₂, and intermediate oxide CeO₂₋₁ (0≤x≤0.5) may be formed in the process of interconversion, so that cerium oxide has strong redox ability.

In addition, due to the low solubility in water, Ce₂O₃ and CeO₂ have a slow releasing rate of cerium ions, cerium oxide can be retained in the coating layer for a long period of time, thus continuously filling in the mesh structure of low surface energy silane material to play a corrosion mitigation role. Similarly, lanthanum oxide, vanadium oxide, praseodymium oxide, molybdenum oxide, zinc oxide, and zirconium oxide can be configured to lanthanum ions, praseodymium ions, molybdenum ions, zinc ions, and zirconium ions, respectively, which have corrosion mitigation properties, and these oxides have property of electrical insulating and water-insoluble or slightly water-soluble, and thus may be added to coating layer as corrosion inhibiting particles for use in mitigating corrosion of the metal matrix.

In some embodiments, the corrosion inhibiting particles are nanoparticles with a particle size of 10 to 100 nm. The particle size of the corrosion inhibiting particles needs to be compatible with the thickness of the hydrophobic coating layer, and too large or too small particle size of the particles will weaken the barrier effect of the coating layer itself on the corrosive medium. Particles with too large a particle size increase the internal defects of the coating layer, particles with too small a particle size incline to agglomerate and not easy to be dispersed in the coating layer, which results in that the particles are unevenly filled in the micropores or pores of the mesh structure of the low surface energy silane type material, besides the particles with a small particle size corresponds to high preparation cost. In order to reduce the effect of the hydrophobic coating layer on the heat transfer performance of the heat exchanger, the hydrophobic coating layer on the surface of the heat exchanger of the present disclosure is thin. In some embodiments, the weight per unit area of the hydrophobic coating layer is 0.1 to 1.0 g/m². Accordingly, the particle size of the corrosion inhibiting particles is selected to be in a range of 10 to 100 nm in the present disclosure, so that the particles can be uniformly filled in the mesh structure of the low surface energy silane material without significant increase in the internal defects of the coating layer.

In some embodiments, the low surface energy silane material includes a silane grafted with a hydrophobic group thereon, the hydrophobic group is selected from at least one of a hydrocarbon group, a halogen atom, and a nitro group. In some embodiments, the hydrocarbon group may be —CₙH₂ₙ₊₁ (n≥1), —CH═CH₂, or —C₆H₅; the halogen atom may be —F, —Cl, —Br, —I, or —At; and the nitro group has the chemical formula —NO₂. In some embodiments, for example, the low surface energy silane material may be selected from one or more of 1H,1H,2H,2H-perfluorodecyltriethoxysilane, 1H,1H,2H,2H-perfluorodecyltrimethoxysilane, 1H,1H,2H,2H-perfluorooctyltriethoxysilane, octadecyltrimethoxysilane, and hexadecyltrimethoxysilane.

In some embodiments, the hydrophobic coating layer further includes hydrophobic particles, the hydrophobic particles have a hydrophobic group attached thereon. In other embodiments, at least a portion of the corrosion inhibiting particles have hydrophobic groups attached thereon. In this way, on the basis of the hydrophobic properties provided by the low surface energy silane material, the hydrophobic properties of the coating layer can be further improved by the hydrophobic particles and/or the corrosion inhibiting particles with hydrophobic groups attached thereon. In some embodiments, the hydrophobic particles may be added to the coating material, alternatively, hydrophobic treatment may be performed to at least a portion of the corrosion inhibiting particles, so that the corrosion inhibiting particles have hydrophobic properties; alternatively, the addition of the hydrophobic particles is accompanied with hydrophobic treatment of at least a portion of the corrosion inhibiting particles. In some embodiments, the hydrophobic group attached to the surface of the hydrophobic particles or the corrosion inhibiting particles are selected from at least one type of hydrocarbon groups, halogen atoms, and nitro groups. In some embodiments, the hydrocarbon group can be —CₙH₂ₙ₊₁ (n≥1), —CH═CH₂, or —C₆H₅; the halogen atom can be —F, —Cl, —Br, —I, or —At; and the nitro group has a chemical formula of —NO₂. In some embodiments, the hydrophobic particle is a nanoparticle with a particle size of 10 to 100 nm.

In some embodiments, the hydrophobic coating layer includes 0.5 to 1.5 parts by mass of the low surface energy silane material and 0.1 to 5 parts by mass of the corrosion inhibiting particles; alternatively, the hydrophobic coating layer includes 0.5 to 1.5 parts by mass of the low surface energy silane material, 1 to 4 parts by mass of the hydrophobic particles, and 0.1 to 1 part by mass of the corrosion inhibiting particles.

Unless otherwise indicated, percentages, proportions or parts are measured by mass herein, where “part by mass” refers to a basic measurement unit for the mass proportionality of a plurality of components, and I part by mass may represent any unit mass, for example, 1 part by mass may represent 1 g, 1.68 g, 5 g, etc.

When the hydrophobic coating layer includes 0.5 to 1.5 parts by mass of the low surface energy silane material and 0.1 to 5 parts by mass of the corrosion inhibiting particles, the surfaces of the corrosion inhibiting particles may have no hydrophobic groups connected thereon, or the surfaces of part of the corrosion inhibiting particles may have the hydrophobic groups connected thereon.

When the hydrophobic coating layer includes 0.5 to 1.5 parts by mass of the low surface energy silane material, 1 to 4 parts by mass of hydrophobic particles, and 0.1 to 1 part by mass of corrosion inhibiting particles, the surfaces of the corrosion inhibiting particles may have no hydrophobic groups connected thereon, or the surfaces of part of the corrosion inhibiting particles may have the hydrophobic groups connected thereon.

A ratio of the low surface energy silane material, the hydrophobic particles and the corrosion inhibiting particles, or a ratio of the low surface energy silane material and the corrosion inhibiting particles according to the present disclosure is beneficial to maintaining good hydrophobic performance of the hydrophobic coating layer, and on this basis, significantly improving the barrier effect of the hydrophobic coating layer, thereby enabling the hydrophobic coating layer to improve the corrosion resistance of the surface of the heat exchanger, and to achieve a better level of performance.

In some embodiments, a static contact angle between the hydrophobic coating layer and water is greater than 150°, and a droplet rolling angle of the hydrophobic coating layer is less than 5°.

In some embodiments, at least part of the surface of the matrix is covered with a rare earth conversion film, the rare earth conversion film includes a rare earth compound, and at least part of the rare earth conversion film is sandwiched between the matrix and the hydrophobic coating layer. The rare earth conversion film sandwiched between the matrix and the hydrophobic coating layer means that one side of the rare earth conversion film is in direct contact with the matrix, the other side of the rare earth conversion film is in direct contact with the hydrophobic coating layer, the hydrophobic coating layer is far away from the matrix with respect to the rare earth conversion film, the rare earth conversion film is disposed between the heat exchanger matrix and the hydrophobic coating layer, and the hydrophobic coating layer is adhered to the surface of the heat exchanger matrix through the rare earth conversion film. In some cases, the hydrophobic coating layer on the heat exchanger surface may be in direct contact with the heat exchanger matrix; alternatively, a rare earth conversion film is sandwiched between the hydrophobic coating layer and the heat exchanger matrix; alternatively, a portion of the hydrophobic coating layer is in direct contact with the heat exchanger matrix, and a rare earth conversion film is sandwiched between another portion of the hydrophobic coating layer and the heat exchanger matrix. In some embodiments, the whole rare earth conversion film may be disposed between the heat exchanger matrix and the hydrophobic coating layer; or, one portion of the rare earth conversion film may be disposed between the heat exchanger matrix and the hydrophobic coating layer, and the other portion of the rare earth conversion film may have one side in direct contact with the heat exchanger matrix, and the other side may be exposed to the external environment, that is, the other portion of the rare earth conversion film have no hydrophobic coating layer applied thereto, and thus a portion of the heat exchanger matrix is merely coated with the rare earth conversion film. The rare earth compounds in the rare earth conversion film can further improve the corrosion resistance of the heat exchanger.

In some embodiments, the rare earth compound includes at least one of a rare earth oxide and a rare earth hydroxide. For example, the rare earth compound may be cerium oxide (CeO₂), cerium trioxide (Ce₂O₃), cerium hydroxide (Ce(OH)₄), and the like. Similarly, the rare earth compounds may be compounds of other rare earth elements, such as La, Pr, Nd, Pm, Sm, Eu, Gd, Tb, Dy, Ho, Er, Tm, Yb, Lu, Sc, Y.

In some embodiments, the sum of the weight per unit area of the hydrophobic coating layer and the weight per unit area of the rare earth conversion film is greater than or equal to 0.1 g/m² and less than or equal to 1.0 g/m².

In some embodiments, the heat exchanger includes a collecting pipe, a fin, and a plurality of heat exchanger tubes, each of the plurality of the heat exchanger tubes is fixed to the collecting pipe, an inner cavity of the heat exchanger tube is in communication with an inner cavity of the collecting pipe, at least part of the fin is retained between two adjacent heat exchanger tubes, and the matrix of the heat exchanger includes a matrix of at least one type of the collecting pipe, the heat exchanger tubes and the fins. In some embodiments, the heat exchanger is a micro-channel heat exchanger. At least part of a surface of at least one of the matrices of the collecting pipe, the heat exchanger tubes and the fins is coated with the hydrophobic coating layer, or a combination of the hydrophobic coating layer and a rare earth conversion film.

The heat exchanger of the present disclosure is exemplarily described below by taking the micro-channel heat exchanger as an example.

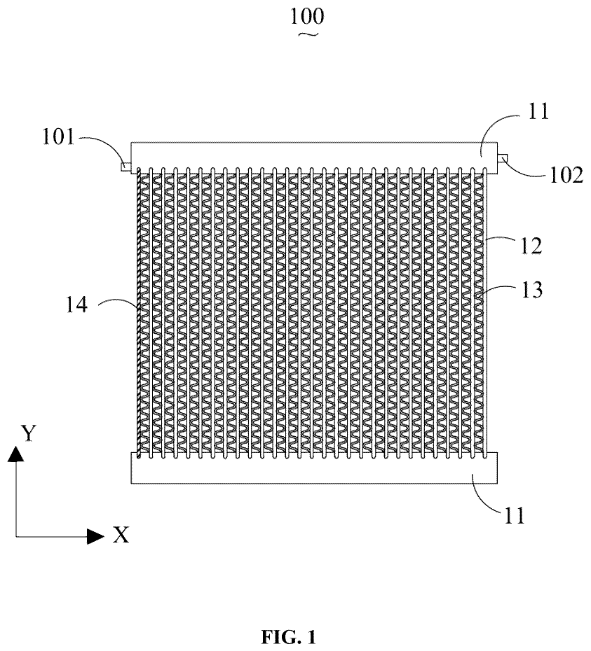

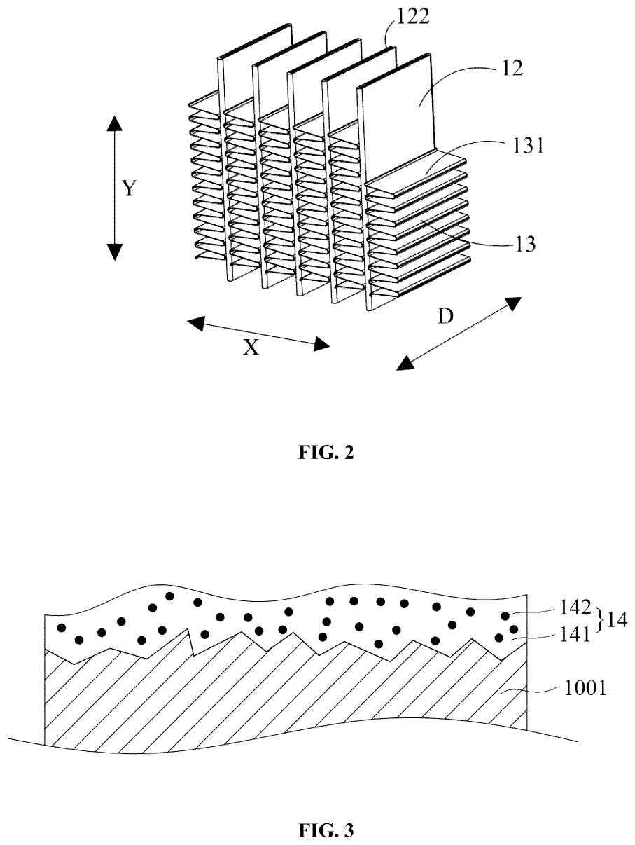

As shown in FIG. 1 and FIG. 2, the present disclosure provides a heat exchanger 100, the heat exchanger 100 includes a collecting pipe 11, a plurality of heat exchanger tubes 12 and a plurality of fins 13. Each of the plurality of heat exchanger tubes 12 is fixed to the collecting pipe 11, the heat exchanger tube 12 is provided with a plurality of channels 122 for refrigerant circulation, and each of the plurality of channels 122 of the heat exchanger tubes 12 are in communication with the inner cavity of the collecting pipe 11. At least part of the fin 13 are retained between two adjacent heat exchanger tubes 12. The collecting pipe 11 is provided with a fluid inlet 101 and a fluid outlet 102 that are in communication with its inner cavity, thereby facilitating fluid entry into the heat exchanger.

The plurality of heat exchanger tubes 12 are arranged along a length direction of the collecting pipe 11, the length direction of the collecting pipe 11 refers to the X direction in FIG. 1. The heat exchanger tube 12 has a longitudinally extending tubular structure, a length direction of the heat exchanger tube 12 refers to the Y direction in FIG. 1, and a width direction of the heat exchanger tube 12 refers to the D direction in FIG. 2. The dimension of the heat exchanger tube 12 along the width direction of is larger than the dimension of the heat exchanger tube 12 along the thickness direction, and the thickness direction of the heat exchanger tube 12 coincides substantially with the length direction of the collecting pipe 11. Moreover, the width direction of the heat exchanger tube 12 is not co-directional with the length direction of the collecting pipe 11. In FIG. 2, the width direction (D direction) of the heat exchanger tube 12 is substantially perpendicular to the length direction (X direction) of the collecting pipe 11.

In FIG. 1, the heat exchanger 100 includes two collecting pipes 11, and two ends of the heat exchanger tubes 12 in the length direction are inserted into the inner cavities of the two collecting pipes 11, respectively. This type of heat exchanger is also commonly referred to as a single row heat exchanger in the industry. In some other embodiments, the heat exchanger 100 may include one collecting pipe 11 or more than two collecting pipes. Correspondingly, the number of heat exchanger tubes and the number of fins are set according to the actual product needs.

In some embodiments, as shown in FIG. 2, the fins 13 are wave-shaped along the length direction (Y direction) of the heat exchanger tube 12. The fin 13 includes a plurality of fin units 131 arranged along the length direction of the heat exchanger tube 12, the plurality of fin units 131 are connected sequentially along the length direction of the heat exchanger tube 12 to form a waveform structure, a position where two adjacent fin units 131 are connected is a peak or a trough in the waveform structure, and the fin 13 is secured to the heat exchanger tube 12 at the position where the two adjacent fin units 131 are connected. During assembly, the components such as the collecting pipe 11, the fins 13, and the heat exchanger tubes 12 can be pre-assembled together, with the collecting pipe 11 being fixed to the heat exchanger tube 12 and the fins 13 being fixed between two adjacent heat exchanger tubes through a brazing process.

The heat exchanger 100 includes a matrix 100-1 and a hydrophobic coating layer 14 coated at least part of the surface of the matrix 100-1, the matrix 100-1 is a matrix of at least one of the collecting pipe 11, the heat exchanger tube 12 and the fin 13.

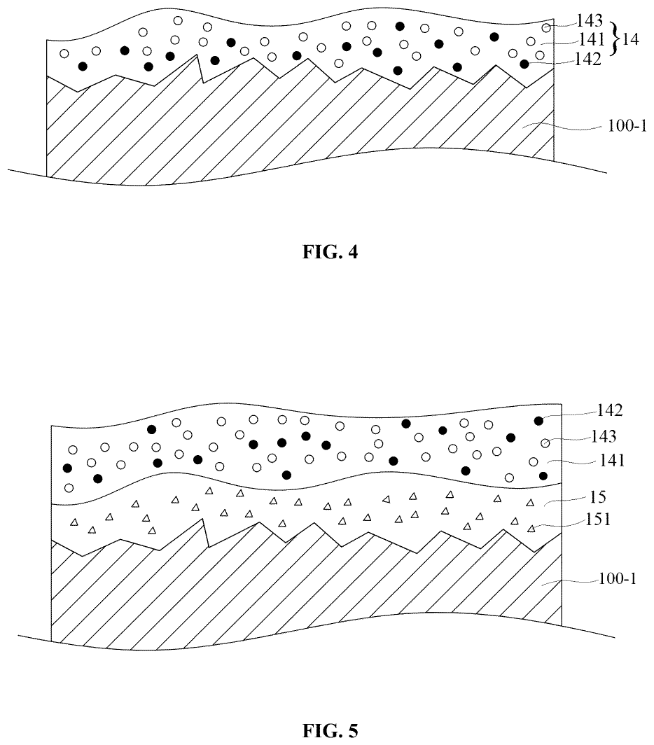

FIG. 3 is a schematic diagram of a cross-section of a surface of a heat exchanger matrix according to an embodiment of the present disclosure. As shown in FIG. 3, the surface of the heat exchanger matrix 100-1 is overlaid with a hydrophobic coating layer 14, the hydrophobic coating layer includes a low surface energy silane material 141 and corrosion inhibiting particles 142 which are shown as solid circles dispersed in the low surface energy silane material. The corrosion inhibiting particles 142 are configured to react with at least one of hydrogen ions, hydroxide ions, and metal ions to form a product that is insoluble or slightly soluble in water. In some embodiments, as shown in FIG. 4, the hydrophobic coating layer further includes hydrophobic particles 143 which are shown as hollow circles.

FIG. 5 shows a schematic diagram of a cross-section of a surface of a heat exchanger matrix according to another embodiment of the present disclosure. As shown in FIG. 5, the surface of the heat exchanger matrix 100-1 is overlaid with a rare earth conversion film 15, the rare earth conversion film 15 includes a rare earth compound 151 which is shown as triangles, and the rare earth conversion film 15 is disposed between the heat exchanger matrix 100-1 and the hydrophobic coating layer 14.

In other embodiments, the heat exchanger of the present disclosure may also be a plate heat exchanger, a tube-and-sheet heat exchanger, a shell-and-tube heat exchanger, a round tube-and-fin heat exchanger, a water-cooled plate, a direct-cooled plate, or the like for refrigerant or coolant flow. That is, the hydrophobic coating layer, or a combination of hydrophobic coating layer and rare earth conversion film of the present disclosure can be used for surface anticorrosion treatment not only for channel heat exchangers, but also for plate heat exchangers, tube-and-sheet heat exchangers, shell-and-tube heat exchangers, round tube-and-fin heat exchangers, water-cooled plates, direct-cooled plates, or the like.

A second aspect of the present disclosure provides a manufacturing method of a heat exchanger, including following steps in sequence:
Step S11, providing a matrix having a channel for fluid flow;
Step S21, providing a composite material, the composite material including a solvent, a low surface energy silane material and corrosion inhibiting particles; and
Step S31, coating the composite material on at least part of a surface of the matrix provided by S11, and curing, to form a hydrophobic coating layer coated on at least part of the surface of the matrix.

The properties and types of the low surface energy silane materials, the properties and types of the corrosion inhibiting particles, and the like are described with reference to the foregoing and will not be repeated herein.

In some embodiments, the matrix of the heat exchanger provided at step S11 is subjected to a surface blasting treatment. Specifically, in some embodiments, the surface sandblasting treatment specifically includes following steps: subjecting the surface of the heat exchanger matrix to a 100 to 200 mesh white corundum sandblasting treatment, with a sandblasting angle of 30° to 60°, a distance between the spray gun and the matrix of 30 to 60 mm, and a number of times of sandblasting of greater than or equal to 1, and then ultrasonically cleaning or spraying the surface of the heat exchanger with alcohol or water, and air drying it or drying it at 35° C. to 50° C. The sandblasting treatment can increase the surface roughness of the matrix, which can lead to a more solid adhesion of the hydrophobic coating layer on the surface of the heat exchanger matrix. In some embodiments, the roughness Ra of the surface of the heat exchanger matrix is 0.5 μm to 10 μm, and in some embodiments, the roughness Ra of the surface of the heat exchanger matrix is 1 μm to 3 μm, for example, it may be 1 μm, 1.2 μm, 1.4 μm, 1.6 μm, 1.8 μm, 2.0 μm, 2.2 μm, 2.4 μm, 2.6 μm, 2.8 μm, 3 μm, and the like.

In some embodiments, in step S31, the means of coating the composite material on at least part of the surface of the matrix includes, but is not limited to, at least one of dip coating, spraying, brushing, drenching, and roller coating.

In some embodiments, in step S31, the curing can be done, for example, by drying in an oven. In some embodiments, the curing temperature is from 60° C. to 180° C. In some embodiments, the curing time is 5 min to 35 min.

In some embodiments, before step S31 and after step S11, the method further includes: step S41, forming a rare earth conversion film on at least part of the surface of the matrix of the heat exchanger. There is no limitation on the order of steps S41 and S21, and step S41 may precede or follow step S21.

In some embodiments, step S41 includes following steps: preparing a rare earth conversion solution, submerging the matrix in the rare earth conversion solution, removing the matrix, and then drying the surface of the matrix. In other embodiments, the rare earth conversion solution may also be coated on the surface of the matrix by dipping, spraying, brushing, drenching, or roll-coating.

In some embodiments, the rare earth conversion solution includes a rare earth raw material, an oxidizing agent and water.

In some embodiments, the rare earth conversion solution includes 1 to 3 parts by mass of rare earth raw material, 92.5 to 97.5 parts by mass of water, and 1.5 to 4.5 parts by mass of oxidant.

In some embodiments, the method of preparing the rare earth conversion solution includes: dissolving the rare earth raw material in water, and then adding the oxidizing agent to make the rare earth conversion solution.

In some embodiments, the method of preparing the rare earth conversion solution may include: dissolving 1 to 3 parts by mass of the rare earth raw material in 92.5 to 97.5 parts of deionized water, and mixing, to obtain an intermediate solution; heating the intermediate solution to 45° C. to 55° C., and then adding 1.5 to 4.5 parts by mass of oxidizing agent to the system, and continuingly mixing to obtain the rare earth conversion solution.

The above rare earth raw material refers to a raw material that can provide rare earth elements, such as raw material that can provide cerium (Ce) elements. In some embodiments, the rare earth raw material includes, but is not limited to, one or a combination of at least two of cerium nitrate hexahydrate, cerium nitrate anhydrous, cerium chloride and polyhydric compounds thereof, cerium sulfate and polyhydric compounds thereof, cerium acetate and polyhydric compounds thereof. The aforementioned cerium chloride and polyhydric compounds thereof are anhydrous cerium chloride, polyhydric compounds of cerium chloride such as cerium chloride heptahydrate or cerium chloride octahydrate, and the like. Similarly, the above cerium sulfate and polyhydric compounds thereof are anhydrous cerium sulfate, polyhydric compounds of cerium sulfate such as cerium sulfate tetrahydrate; and cerium acetate and polyhydric compounds thereof are anhydrous cerium acetate, polyhydric compounds of cerium acetate such as cerium acetate trihydrate or cerium acetate tetrahydrate, and the like.

In some embodiments, the oxidizing agent includes, but is not limited to, at least one of hydrogen peroxide, sodium perchlorate and tert-butyl hydroperoxide. For example, the oxidizing agent may be an aqueous hydrogen peroxide solution (with a mass concentration of hydrogen peroxide of about 27.5 wt. % to 30 wt. %), or the oxidizing agent may be sodium perchlorate, or the oxidizing agent may be an aqueous tert-butylhydrogen peroxide solution or a n-butanol solution of tert-butylhydrogen peroxide (with a mass concentration of tert-butylhydrogen peroxide of not less than 60 wt. %).

A third aspect of the present disclosure provides a composite material for surface anticorrosion treatment of a heat exchanger, the composite material includes a solvent, a low surface energy silane material and corrosion inhibiting particles. An anticorrosion coating layer can be formed on the surface of the heat exchanger via the composite material, and the corrosion resistance of the heat exchanger can be improved via the synergistic action of the low surface energy silane material and the corrosion inhibiting particles.

In some embodiments, the solvent is selected from at least one of ethanol, methanol and isopropanol.

The properties and types of the low surface energy silane materials, the properties and types of the corrosion inhibiting particles, and the like are described with reference to the foregoing and will not be repeated herein.

In some embodiments, the composite material further includes hydrophobic particles, the hydrophobic particles have hydrophobic groups attached thereon.

In some embodiments, the composite material includes 93.5 to 99.4 parts by mass of solvent, 0.5 to 1.5 parts by mass of low surface energy silane material, and 0.1 to 5 parts of corrosion inhibiting particles; alternatively, the composite material includes 93.5 to 98.4 parts by mass of solvent, 0.5 to 1.5 parts by mass of low surface energy silane material, 0.1 to 1 part of corrosion inhibiting particles, and 1 to 4 parts of hydrophobic particles, where the hydrophobic particles having a hydrophobic group.

In some embodiments, the composite material provided in step S21 is self-prepared.

A fourth aspect of the present disclosure provides a preparing method of the composite material, the preparing method includes following step: mixing a solvent, a low surface energy silane material, and corrosion inhibiting particles to obtain the composite material. Alternatively, the preparing method includes following step: mixing a solvent, a low surface energy silane material, hydrophobic particles and corrosion inhibiting particles to obtain the composite material.

In the present disclosure, the mixing may be performed by mechanical mixing, ultrasonic dispersion, or other means. The raw material may be added to the solvent all at once, or in two or more times, and the present disclosure does not impose any limitations on the mixing method, the order of addition, the method of addition, and the number of times of addition. In some embodiments, the hydrophobic particles and/or corrosion inhibiting particles are added to the solvent in two or more portions, to facilitate the dispersion of the hydrophobic particles and/or corrosion inhibiting particles in the composite material, so that the hydrophobic particles and/or corrosion inhibiting particles are uniformly dispersed in the mesh structure formed by the low surface energy silane material.

In some embodiments, the preparing method of the composite material includes following step: performing hydrophobic treatment on at least part of the corrosion inhibiting particles. In doing so, at least part of the corrosion inhibiting particles have a hydrophobic group attached thereon.

In some embodiments, the preparing method of the composite material includes: mixing 93.5 to 99.4 parts by mass of the solvent, 0.5 to 1.5 parts by mass of the low surface energy silane material and 0.1 to 5 parts by mass of the corrosion inhibiting particles, to obtain the composite material. Alternatively, the preparing method of the composite material includes: mixing 93.5 to 98.4 parts by mass of the solvent, 0.5 to 1.5 parts by mass of the low surface energy silane material, 0.1 to 1 part by mass of the corrosion inhibiting particles and 1 to 4parts by mass of the hydrophobic particles, to obtain the composite material.

In order to facilitate the understanding of the present disclosure, the present disclosure has been verified by several sets of experiments. The present disclosure is further described below in combination with specific embodiments and comparative examples. In order to facilitate performance testing, plates were used instead of heat exchangers for sample preparation. That is, a plate sheet made of the same material as the heat exchanger was used, and a relevant coating was applied to the plate sheet to form a coating layer for testing. In the actual preparation process, the surface treatment of the heat exchanger may be carried out using the same steps as the surface treatment of the plate sheet of the present embodiments.

### Embodiment 1

### Step 1, Surface Pretreating

Sandblasting treatment was performed on a plate by using 120 mesh white corundum, with an angle between a spray gun and the positing to be coated being about 45° C., and a distance between the spray gun and the position to be coated being 50 mm. The sandblasting treatment was performed for 1 time. Then anhydrous ethanol was sprayed to clean the plate, and the plate was dried under 40° C.

### Step 2, Forming a Rare Earth Conversion Film

Step 2.1, 1 part by mass of cerium nitrate hexahydrate was weighed and added into a beaker, 95.1 parts by mass of deionized water was added, and mechanically stirred until the solid was completely dissolved. The obtained solution was colorless and transparent. The solution was heated to 50° C. in a water bath, 2.4 parts by mass of tert-butyl hydroperoxide in n-butanol solution with the mass fraction of tert-butyl hydroperoxide being greater than 70% was added, and continued to stir and heat to 50° C., to prepare the rare earth conversion solution.

Step 2.2, the plate subjected to the surface pretreatment according to Step 1 was immersed into the rear earth conversion solution prepared according to Step 2.1, subjected to static insulation under 50° C. for 40 min, and dried by cold air or natural drying, so as to form the rear earth conversion film on the plate.

Where the main equation of the rare earth conversion film formation was:

Al→Al³⁺+3e⁻;

O₂+2H₂O+4e⁻→4OH⁻;

Ce³⁺+3OH⁻→Ce(OH)₃;

2Ce(OH)₃→Ce₂O₃+3H₂O.

### Step 3, Preparing Composite Material

97 parts by mass of ethanol, 1 part by mass of 1H,1H,2H,2H-perfluorodecyltrimethoxysilane and 2 parts by mass of cerium dioxide nanoparticles was weighed, ultrasonically dispersed for 15 min, and mechanically stirred for 30 min, to obtain the composite material, where the cerium oxide nanoparticles act as corrosion inhibition particles, and have particle sizes of 20 to 50 nm.

### Step 4, Coating Plate

After Step 2, the pate coated with the rear earth conversion film was immersed into the composite material prepared in Step 3 for 2 min, then put into an oven, and cured under 120° C. for 20 min, to obtain the plate having the rear earth conversion film and the hydrophobic coating layer coated thereon.

### Embodiments 2 and 3

Embodiments 2 and 3 differed from Embodiment 1 in the mass parts of 1H,1H,2H,2H-perfluorodecyltrimethoxysilane and cerium dioxide nanoparticles in Step 3. The rest was the same as in Embodiment 1.

In Embodiment 2, Step 3 included following steps: weighing 99.4 parts by mass of ethanol, 0.5 part by mass of 1H,1H,2H,2H-perfluorodecyltrimethoxysilane and 0.1 part by mass of cerium dioxide nanoparticles, ultrasonically dispersing for 15 min, and mechanically stirring for 30 min, to obtain the composite material.

In Embodiment 3, Step 3 included following steps: weighing 93.5 parts by mass of ethanol, 1.5 parts by mass of 1H,1H,2H,2H-perfluorodecyltrimethoxysilane and 5 parts by mass of cerium dioxide nanoparticles, ultrasonically dispersing for 15 min, and mechanically stirring for 30 min, to obtain the composite material.

### Embodiment 4

Embodiment 4 differed from Embodiment 1 in the preparation of the composite material in Step 3. Step 3 of Embodiment 4 for preparing the composite material included following steps.

Step 3.1, weighing 98 parts by mass of ethanol, 1 part by mass of 1H,1H,2H,2H-perfluorodecyltrimethoxysilane and 1 part by mass of hydrophobic nano-silicon dioxide, ultrasonically dispersing for 15 min, and mechanically stirring for 2 h to obtain sol A.

Step 3.2, taking 98 parts by mass of the sol A prepared in Step 3.1 above, adding 1.5 parts by mass of hydrophobic nano-silicon dioxide and 0.5 parts by mass of cerium oxide nanoparticles, ultrasonically dispersing for 15 min, and mechanically stirring for 30 min, to obtain the composite material, where the hydrophobic nano-silicon dioxide was obtained by treating fumed silica with dichlorodimethylsilane (CAS: 75-78-5), and the particle size of the hydrophobic silica was 5 to 50 nm.

The rest was the same as Embodiment 1.

### Embodiments 5 and 6

Embodiments 5 and 6 differed from Embodiment 4 mainly in the preparation of the composite material in Step 3. The rest was the same as Embodiment 1.

In Embodiment 5, the preparation of the composite material in Step 3 included following steps.

Step 3.1, weighing 99 parts by mass of ethanol, 0.5 part by mass of 1H,1H,2H,2H-perfluorodecyltrimethoxysilane and 0.5 part by mass of hydrophobic nano-silicon dioxide, ultrasonically dispersing for 15 min, and mechanically stirring for 2 h to obtain sol A.

Step 3.2, taking 99.4 parts by mass of the sol A prepared in step 3.1 above, adding 0.5 part by mass of hydrophobic nano-silicon dioxide and 0.1 part by mass of cerium oxide nano-silicon dioxide, ultrasonically dispersing for 15 min, and mechanically stirring for 30 min, to obtain the composite material.

In Embodiment 6, the preparation of the composite material in Step 3 included following steps.

Step 3.1, weighing 96.5 parts by mass of ethanol, 1.5 parts by mass of 1H,1H,2H,2H-perfluorodecyltrimethoxysilane and 2 parts by mass of hydrophobic nano-silicon dioxide, ultrasonically dispersing for 15 min, and mechanically stirring for 2 h to obtain sol A.

Step 3.2, taking 97 parts by mass of the sol A prepared in step 3.1 above, adding 2 parts by mass of hydrophobic nano-silicon dioxide and 1 part by mass of nano-cerium oxide, ultrasonically dispersing for 15 min, and mechanically stirring for 30 min, to obtain the composite material.

### Embodiments 7 to 20

Embodiments 7 to 20 differed from Embodiment 4 in the mass parts of the hydrophobic nano-silicon dioxide and the corrosion inhibiting nano-cerium dioxide in Step 3.2, and the rest was the same as that of Embodiment 4.

Specifically, the amounts of hydrophobic nano-silicon dioxide and corrosion-retarding nano-cerium dioxide in Step 3.2 of Embodiments 7 to 20 were shown in Table 1.

TABLE 1
Amounts of hydrophobic nano-silicon dioxide and corrosion inhibiting
nano-cerium dioxide in step 3.2 of Embodiments 7 to 20.

| | | Corrosion inhibiting nano-cerium dioxide (mass parts) | | | | |
|---|---|---|---|---|---|---|
| | | 0.1 | 0.2 | 0.3 | 0.4 | 0.5 |
| Hydrophobic | 1.5 | Embodiment 7 | Embodiment 8 | Embodiment 9 | Embodiment 10 | Embodiment 4 |
| nano-silicon | 2.0 | Embodiment 11 | Embodiment 12 | Embodiment 13 | Embodiment 14 | Embodiment 15 |
| dioxide | 2.5 | Embodiment 16 | Embodiment 17 | Embodiment 18 | Embodiment 19 | Embodiment 20 |
| (mass parts) | | | | | | |

### Comparative Example 1

Comparative Example 1 differed from Embodiment 1 in Step 3. The preparation of the composite material in Step 3 of Comparative example 1 included following steps.

Step 3.1, weighing 98 parts by mass of ethanol, 1 part by mass of 1H,1H,2H,2H-perfluorodecyltrimethoxysilane and 1 part by mass of hydrophobic nano-silicon dioxide, ultrasonically dispersing for 15 min, and mechanically stirring for 2 h to obtain sol A.

Step 3.2, taking 98 parts by mass of the sol A prepared in Step 3.1 above, adding 2 portions of hydrophobic nano-silicon dioxide, ultrasonically dispersing for 15 min, and mechanically stirring for 30 min to obtain the composite material.

The rest was the same as Embodiment 1.

### Comparative Example 2

Comparative example 2 differed from Embodiment 1 in Step 3. The preparation of composite material in Step 3 of Comparative example 2 included following steps.

Step 3.1, weighing 98 parts by mass of ethanol, 1 part by mass of 1H,1H,2H,2H-perfluorodecyltrimethoxysilane and 1 part by mass of hydrophobic nano-silicon dioxide, ultrasonically dispersing for 15 min, and mechanically stirring for 2 h to obtain sol A.

Step 3.2, taking 98 parts by mass of the sol A prepared in step 3.1 above, adding 2 parts by mass of cerium oxide nanoparticles, ultrasonically dispersing for 15 min, and mechanically stirring for 30 min to obtain the composite material.

The rest was the same as Embodiment 1.

### Performance Tests

### 1. Hydrophobicity Performance Test (Contact Angle Test)

A contact angle measuring instrument which adopted the image contour analysis method to measure the contact angle of the sample according to the optical imaging principle was adopted. The contact angle refers to an angle formed between two tangents of gas-liquid interface and solid-liquid interface when liquid phase was sandwiched between the two tangents of gas-liquid interface and solid-liquid interface, and located at the three-phase (solid-liquid-gas) junction point on a solid surface after a drop of liquid was dropped on a horizontal plane of the solid.

Before the test, the contact angle measuring instrument and a computer connected thereto were turned on, and a testing software was operated.

A sample was put on a horizontal table, and the amount of droplet was adjusted with a microliter syringe. The volume of the droplet as generally about 1 μL, and the droplet was formed on the needle. A knob was rotated to move the table up, so that the surface of the sample was in contact with the droplet, and then the table was moved down, so that the droplet can be left on the sample.

The contact angle of the area was obtained by test and data analysis through the testing software. Five different points were taken on the samples in each Embodiment and each Comparative Example to test and get an average value of the five different points, and then the average value was recorded as the contact angle of the sample of the Embodiment or the Comparative Example.

The test results of the contact angle showed that initial contact angles of the surfaces of the samples of Embodiments 1 to 20 and Comparative Examples 1 and 2 were all greater than 150°, which indicated excellent hydrophobic property of the hydrophobic coating layer formed on the surface of the sample of Embodiments and Comparative examples.

### 2. Corrosion Resistance Test (Salt Spray Test)

The plate samples of the Embodiments 1 to 20 and Comparative examples 1 and 2 were subjected to a salt spray test, respectively. The salt spray test was conducted with reference to the test standard ASTM G85, and the acidic salt spray test was conducted by placing each sample into a salt spray box and removing it at certain intervals to observe the surface corrosion point condition. After the acidic salt spray test, the samples were removed for observing the surface corrosion and recording the time of corrosion spots.

Affected by the state of the salt spray box and the placement of the sample position, the samples made from the same formula may differ in salt spray test results. Therefore, in order to better compare the corrosion resistance of plates prepared with different formulations, the present disclosure compared samples in the same period of salt spray test.

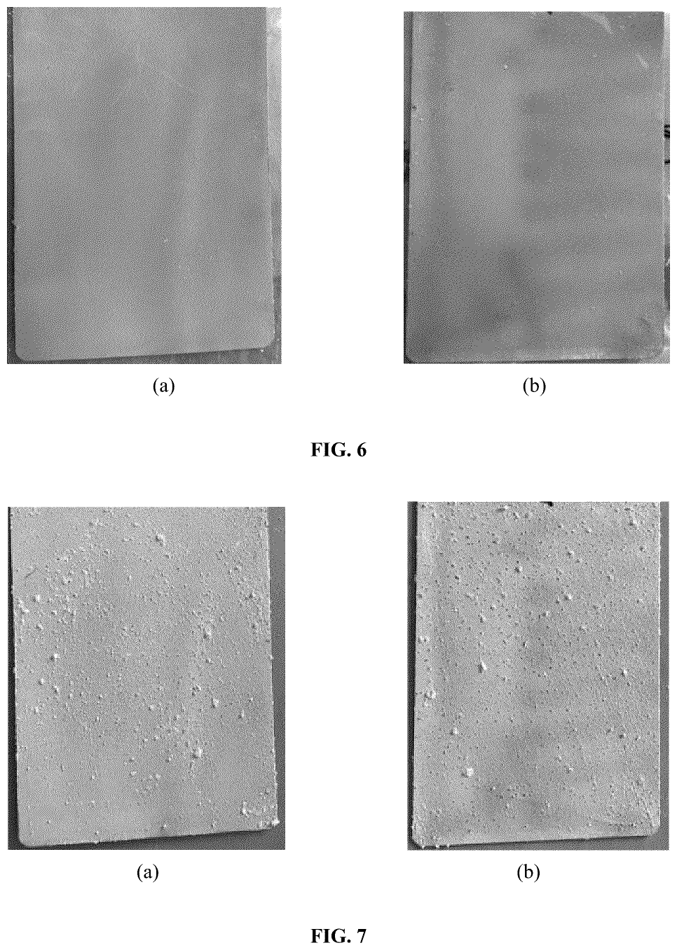

The present disclosure compared the samples of Comparative example 1 and Comparative example 2. In 48 h salt spray test, the surface morphologies of the samples of Comparative example 1 and Comparative example 2 are shown in FIG. 6, where FIG. 6(a) shows the surface morphology of the sample of Comparative example 1, and FIG. 6(b) shows the surface morphology of the sample of Comparative example 2. In 96 h salt spray test, the surface morphologies of the samples of Comparative example 1 and Comparative example 2 are shown in FIG. 7, where FIG. 7(a) shows the surface morphology of the sample of Comparative example 1, and FIG. 7(b) shows the surface morphology of the sample of Comparative example 2. It can be seen from FIG. 6 and FIG. 7, the salt spray resistance of samples of Comparative example 1 and Comparative example 2 are comparable.

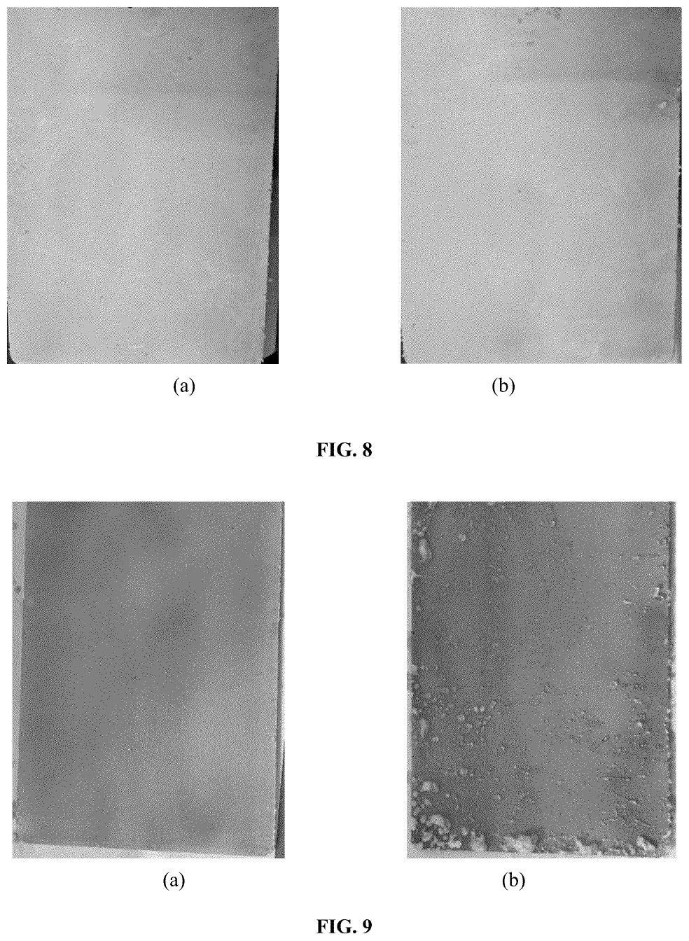

The present disclosure also compares the sample of Embodiment 4 with the sample of the Comparative example 1. In 240 h salt spray test, the surface morphologies of the samples of Embodiment 4 and Comparative example 1 are shown in FIG. 8, where FIG. 8(a) shows the surface morphology of the sample of Embodiment 4, and FIG. 8(b) shows the surface morphology of the sample of Comparative example 1. In 96 h salt spray test, the surface morphologies of the sample of Embodiment 4 and the sample of Comparative example 1 are shown in FIG. 9, where FIG. 9(a) shows the surface morphology of the sample of Embodiment 4, and FIG. 9(b) shows the surface morphology of the sample of Comparative example 1. As can be seen from FIG. 8, there is not much difference between the surface morphology of the sample of Embodiment 4 and that of Comparative example 1 in the 240 h salt spray test, but as can be seen from FIG. 9, the rust spots on the surface of the samples of Embodiment 4 are significantly less than that of Comparative example 1 in the 96 h salt spray test, which indicates that the corrosion resistance performance of sample of Embodiment 4 is better than that of Comparative example 1, and the corrosion resistance of the samples can be significantly improved by addition of the corrosion inhibition particles of cerium oxide and hydrophobic particles of silicon dioxide.

In addition, the present disclosure also tested the SWAAT salt spray resistance time of Embodiments 1 to 20, and the SWAAT salt spray resistance time of Embodiments 1 to 20 is shown in Table 2.

TABLE 2
SWAAT salt spray resistance time for samples of Embodiments 1 to 20.

| Embodiment | 1 | 2 | 3 | 4 | 5 | 6 | 7 | 8 | 9 | 10 |
|---|---|---|---|---|---|---|---|---|---|---|
| SWAAT salt | 240 | 240 | 240 | 312 | 240 | 240 | 240 | 312 | 312 | 312 |
| spray | | | | | | | | | | |
| resistance time | | | | | | | | | | |
| (h) | | | | | | | | | | |
| Embodiment | 11 | 12 | 13 | 14 | 15 | 16 | 17 | 18 | 19 | 20 |
| SWAAT salt | 240 | 240 | 240 | 312 | 240 | 240 | 240 | 312 | 240 | 240 |
| spray | | | | | | | | | | |
| resistance time | | | | | | | | | | |
| (h) | | | | | | | | | | |

240 h is the SWAAT salt spray resistance time for heat exchangers subjected to surface treatment (TCP) by using chromic acid in the current market. Specifically, the surface treatment (TCP) of the heat exchanger by using chromic acid includes following steps: cleaning the plate with a degreasing cleaning solution, rinsing it with deionized water, and then heating the TCP passivation solution to 40° C., immersing the plate into the passivation solution for 2 min, removing it and placing it into a 40° C. oven, and drying it at 40° C. for 10min, to obtain the sample.

According to Table 2, it can be seen that within the range of ratios of the corrosion inhibiting cerium dioxide and low surface energy silane material of the present disclosure, alternatively, within the range of ratios of hydrophobic silica, corrosion inhibiting cerium dioxide, and low surface energy silane material of the present disclosure, the composite material of the present disclosure can enable the heat exchanger to have a good corrosion resistance, which is capable of rivaling, or even outperforming, the commercially available TCP-treated heat exchanger in terms of corrosion resistance.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the present disclosure, and all technical solutions and improvements that do not depart from the spirit and scope of the application should be covered by the claims of the present disclosure.

What is claimed is:

1. A heat exchanger, comprising:
a matrix having a channel for fluid flow; and
a coating layer coated on at least part of a surface of the matrix, the coating layer including a hydrophobic layer;
wherein the hydrophobic layer includes a low surface energy silane material and corrosion inhibiting particles distributed in the low surface energy silane material.

2. The heat exchanger according to claim 1, wherein the corrosion inhibiting particles are configure to release corrosion inhibiting ions, and the corrosion inhibiting ions are selected from at least one type of cerium ions, vanadium ions, lanthanum ions, praseodymium ions, molybdenum ions, zinc ions and zirconium ions.

3. The heat exchanger according to claim 1, wherein the corrosion inhibiting particles are insoluble or slightly soluble in water;
a resistivity of the corrosion inhibiting particles is 10⁹ Ω·cm to 10²² Ω·cm.

4. The heat exchanger according to claim 1, wherein the corrosion inhibiting particles are nanoparticles with particle sizes of 10 nm to 100 nm.

5. The heat exchanger according to claim 1, wherein the low surface energy silane material comprises silane with a hydrophobic group grafted on the surface, and the hydrophobic group is selected from at least one of a hydrocarbyl group, a halogen atom and a nitro group.

6. The heat exchanger according to claim 1, wherein the hydrophobic coating layer further comprises hydrophobic particles, and surfaces of the hydrophobic particles are connected with hydrophobic groups;
at least part of surfaces of the corrosion inhibiting particles are connected with hydrophobic groups.

7. The heat exchanger according to claim 6, wherein the hydrophobic coating layer comprises 0.5 to 1.5 parts by mass of the low surface energy silane material and 0.1 to 5 parts by mass of the corrosion inhibiting particles; or, the hydrophobic coating layer comprises 0.5 to 1.5 parts by mass of a low surface energy silane material, 1 to 4 parts by mass of hydrophobic particles and 0.1 to 1 part by mass of corrosion inhibiting particles.

8. The heat exchanger according to claim 1, wherein the coating layer comprises a rare earth conversion film covering at least part of the surface of the matrix, the rare earth conversion film comprises a rare earth compound, and at least part of the rare earth conversion film is sandwiched between the matrix and the hydrophobic coating layer.

9. The heat exchanger according to claim 1, wherein the heat exchanger comprises a collecting pipe, a fin and a plurality of heat exchange tubes, the heat exchange tube is fixed to the collecting pipe, an inner cavity of the heat exchange tube communicates with an inner cavity of the collecting pipe, at least part of the fin is retained between two adjacent heat exchange tubes, and the matrix is a matrix of at least one of the collecting pipe, the heat exchange tubes and the fin.

10. A composite material for a heat exchanger, comprising:
a low surface energy silane material, the low surface energy silane material comprising a silane with a hydrophobic group grafted thereon, and the hydrophobic group being selected from at least one of a hydrocarbyl group, a halogen atom and a nitro group; and
corrosion inhibiting particles, the corrosion inhibiting particles being configured to releasing corrosion inhibiting ions, and the corrosion inhibiting ions being selected from at least one type of cerium ions, vanadium ions, lanthanum ions, praseodymium ions, molybdenum ions, zinc ions and zirconium ions.

11. The composite material according to claim 10, wherein the corrosion inhibiting particles are insoluble or slightly soluble in water; a resistivity of the corrosion inhibiting particles is 10⁹ Ω·cm to 10²² Ω·cm, and the corrosion inhibiting particles are nanoparticles with particle sizes of 10 nm to 100 nm.

12. The composite material according to claim 10, wherein at least part of surfaces of the corrosion inhibiting particles are connected with hydrophobic groups.

13. The composite material according to claim 10, wherein the composite material comprises 0.5 to 1.5 parts by mass of the low surface energy silane material and 0.1 to 5 parts by mass of the corrosion inhibiting particles; or,
the composite material comprises 0.5 to 1.5 parts by mass of the low surface energy silane material, 0.1 to 1 part by mass of the corrosion inhibiting particles and 1 to 4 parts by mass of hydrophobic particles, wherein surfaces of the hydrophobic particles are connected with hydrophobic groups.

14. A manufacturing method of a heat exchanger, comprising following steps:
providing a matrix having a channel for fluid flow;
providing a composite material, the composite material comprising a low surface energy silane material and corrosion inhibiting particles; and
coating the composite material on at least part of a surface of the matrix, and curing, to form a hydrophobic coating layer coated on at least part of the surface of the matrix.

15. The manufacturing method according to claim 14, wherein the providing a composite material comprises following steps:
performing hydrophobic treatment on at least part of the corrosion inhibiting particles; and
mixing solvent, the low surface energy silane material and the corrosion inhibiting particles, to obtain the composite material.

16. The manufacturing method according to claim 14, wherein before the coating the composite material on at least part of a surface of the matrix, the manufacturing method comprises following step:
forming a rare earth conversion film on the surface of the matrix.

17. The manufacturing method according to claim 16, wherein the forming a rare earth conversion film on the surface of the matrix, comprises following steps:
preparing a rare earth conversion solution, immersing the matrix in the rare earth conversion solution, taking out the matrix, and then drying the surface of the matrix.

18. The manufacturing method according to claim 17, wherein the preparing a rare earth conversion solution comprises following steps:
dissolving 1 to 3 parts by mass of a rare earth raw material in 92.5 to 97.5 parts by mass of deionized water, and mixing, to obtain an intermediate solution; and heating the intermediate solution to 45° C. to 55° C., then adding 1.5 to 4.5 parts by mass of an oxidizing agent, and continuously mixing, to obtain the rare earth conversion solution.

19. The manufacturing method according to claim 18, wherein the rare earth raw material is selected from one or a combination of at least two of cerium nitrate hexahydrate, anhydrous cerium nitrate, cerium chloride and a multi-water compound thereof, cerium sulfate and a multi-water compound thereof, cerium acetate and a multi-water compound thereof; and
the oxidizing agent is selected from at least one of hydrogen peroxide, sodium perchlorate and tert-butyl hydroperoxide.

20. The manufacturing method according to claim 16, wherein before the forming a rare earth conversion film on the surface of the matrix, the manufacturing method comprises following step:
performing sand blasting treatment on the surface of the matrix by using an abrasive material of 100 to 200 meshes.
